(19) United States
(12) Patent Application Publication
(10) Pub. No.: US 2007/0185262 A1
(43) Pub. Date: Aug. 9, 2007

(54) COMPOSITION FOR FORMING COLORED SILICA-BASED COATING

(75) Inventor: Yoshinori SAKAMOTO, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: TOKYO OHKA KOGYO CO., LTD., Kawasaki-shi (JP)

(21) Appl. No.: 11/671,395

(22) Filed: Feb. 5, 2007

(30) Foreign Application Priority Data
Feb. 7, 2006 (JP) 2006-030329

(51) Int. Cl. C08L 83/04; B32B 27/00

(52) U.S. Cl. 524/588

(57) ABSTRACT

Compositions for forming colored silica-based coatings are provided that are adapted for forming colored layers in order to conceal pattern shapes made on semiconductor elements. The compositions for forming colored silica-based coatings comprise a siloxane polymer, a colorant and a solvent. The siloxane polymer is preferably a ladder-type siloxane polymer.

This application is based on and claims the benefit of priority from Japanese Patent Application No. 2006-030329, filed on 7 Feb. 2006, the content of which is incorporated herein by reference.

### BACKGROUND OF THE INVENTION

1. Field of the Invention

The present invention relates to compositions for forming colored silica-based coatings, in particular to those for forming colored layers that are utilized for concealing pattern shapes made on semiconductor elements.

2. Related Art

Conventionally, silica-based coatings have been frequently utilized for smoothing films or interlayer insulating films of semiconductor elements such as LSIs. These silica-based coatings are usually formed by CVD processes, spin coat processes, etc., and typically exhibit higher transparency such as no less than 90% at wavelengths of 400 nm or more. Therefore, there has been a problem with respect to information leaks of pattern shapes formed on semiconductor elements. For this reason, there has been demands for a process that can conceal the information of pattern shapes, and thus the concealing of pattern shapes has been investigated using colored silica-based coatings. For example, Patent Document 1 discloses a coating liquid for forming colored films.

Patent Document 1: Japanese Unexamined Patent Publication No. Hei 07-082527

However, there is no description in Patent Document 1 in terms of the concealing of pattern shapes formed on semiconductor elements as described above. In addition, it is difficult for the coating liquid described above to improve the colorants dispersibility, coating property and storage stability.

### SUMMARY OF THE INVENTION

In view of the circumstances described above, it is an object of the present invention to provide a composition for forming colored layers, preferably a composition for forming colored silica-based coatings, that has superior coating properties, colorant dispersibility and storage stability.

In order to attain this object, the composition for forming colored silica-based coatings according to the present invention comprises a siloxane polymer, a colorant and a solvent.

The composition for forming colored silica-based coatings according to the present invention can bring about colored silica-based coatings.

### DETAILED DESCRIPTION OF THE INVENTION

The composition for forming colored silica-based coatings according to the present invention comprises a siloxane polymer, a colorant and a solvent.

The siloxane polymer in the present invention is a polymer having a main skeleton of SiO units. The siloxane polymer is exemplified by a hydrolysis product and/or a partial condensate of at least a silane compound expressed by the formula (1) below:

RₙSiX₄₋ₙ (1)

in which each R represents a hydrogen atom or a monovalent organic group, X represents a hydrolyzable group, n is an integer of 0 to 2 and plural Rs may be identical or different each other.

It is preferred that the compounds expressed by the general formula (1) include a compound of n=0, thereby the mechanical strength may be increased. In the case of n=1 or 2, the R(s) is preferably a monovalent organic group.

The monovalent organic group of R described above may be organic groups having a carbon number of 1 to 20. Examples of the organic groups include alkyl groups such as methyl group, ethyl group and propyl group; alkenyl groups such as vinyl group, allyl group and propenyl group; aryl groups such as phenyl group and tolyl group; aralkyl groups such as benzyl group and phenylethyl group; epoxy-containing groups such as glycidyl group and glycidyloxy group; amino groups; and substituted amino-containing groups such as alkylamino groups. Among these, those having a carbon number of 1 to 6 are preferable such as methyl group, ethyl group, propyl group and phenyl group, particularly preferable are methyl group and phenyl group, and most preferable is methyl group.

Examples of the hydrolyzable group X include methoxy group, ethoxy group, propoxy group, isopropoxy group, butoxy group, sec-butoxy group and t-butoxy group; alkenoxy groups such as vinyloxy group and 2-propenoxy group; acyloxy groups such as phenoxy group and acetoxy group; oxime groups such as butanoxime group; amino groups. Among these, alkoxy groups having a carbon number of 1 to 6 are preferable, in particular methoxy group, ethoxy group, isopropoxy group and butoxy group are preferable in view of easy control at hydrolysis and condensation.

The mass average molecular weight (Mw) of the reaction product, which is not necessary to define definitely, is preferably 1000 to 10000, more preferably 1000 to 5000 (gel permeation chromatography, calibrated with polystyrene standard).

Specific examples of the compounds expressed by the general formula (1) include trimethoxysilane, triethoxysilane, tri-n-propoxysilane, triisopropoxysilane, tri-n-butoxysilane, tri-sec-butoxysilane, tri-tert-butoxysilane, triphenoxysilane, fluorotrimethoxysilane, fluorotriethoxysilane, fluorotri-n-propoxysilane, fluorotriisopropoxysilane, fluorotri-n-butoxysilane, fluorotri-sec-butoxysilane, fluorotri-tert-butoxysilane, fluorotriphenoxysilane, tetramethoxysilane, tetraethoxysilane, tetra-n-propoxysilane, tetraisopropoxysilane, tetra-n-butoxysilane, tetra-sec-butoxysilane, tetra-tert-butoxysilane, tetraphenoxysilane, methyltrimethoxysilane, methyltriethoxysilane, methyltri-n-propoxysilane, methyltriisopropoxysilane, methyltri-n-butoxysilane, methyltri-sec-butoxysilane, methyltri-tert-butoxysilane, methyltriphenoxysilane, ethyltrimethoxysilane, ethyltriethoxysilane, ethyltri-n-propoxysilane, ethyltriisopropoxysilane, ethyltri-n-butoxysilane, ethyltri-sec-butoxysilane, ethyltri-tert-butoxysilane, ethyltriphenoxysilane, vinyltrimethoxysilane, vinyltriethoxysilane, vinyltri-n-propoxysilane, vinyltriisopropoxysilane, vinyltri-n-butoxysilane, vinyltri-sec-butoxysilane, vinyltri-tert-butoxysilane, vinyltriphenoxysilane, n-propyltrimethoxysilane, n-propyltriethoxysilane, n-propyltri-n-propoxysilane, n-propyltriisopropoxysilane, n-propyltri-n-butoxysilane, n-propyltri-sec-butoxysilane, n-propyltri-tert-butoxysilane, n-propyltriphenoxysilane, i-propyltrimethoxysilane, i-propyltriethoxysilane, i-propyltri-n-propoxysilane, i-propyltriisopropoxysilane, i-propyltri-n-butoxysilane, i-propyltri-sec-butoxysilane, i-propyltri-tert-butoxysilane, i-propyltriphenoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-tert-butoxysilane, n-butyltriphenoxysilane, sec-butyltrimethoxysilane, sec-butyl-i-triethoxysilane, sec-butyltri-n-propoxysilane, sec-butyltri-iso-propoxysilane, sec-butyltri-n-butoxysilane, sec-butyltri-sec-butoxysilane, sec-butyltri-tert-butoxysilane, sec-butyltriphenoxysilane, t-butyltrimethoxysilane, t-butyltriethoxysilane, t-butyltri-n-propoxysilane, t-butyltri-iso-propoxysilane, t-butyltri-n-butoxysilane, t-butyltri-sec-butoxysilane, t-butyltri-tert-butoxysilane, t-butyltriphenoxysilane, phenyltrimethoxysilane, phenyltriethoxysilane, phenyltri-n-propoxysilane, phenyltriisopropoxysilane, phenyltri-n-butoxysilane, phenyltri-sec-butoxysilane, phenyltri-tert-butoxysilane, phenyltriphenoxysilane, vinyltrimethoxysilane, vinyltriethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-trifluoropropyltrimethoxysilane, gamma-trifluoropropyltriethoxysilane, dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-tert-butoxysilane, dimethyldiphenoxysilane, diethyldimethoxysilane, diethyldiethoxysilane, diethyldi-n-propoxysilane, diethyldiisopropoxysilane, diethyldi-n-butoxysilane, diethyldi-sec-butoxysilane, diethyldi-tert-butoxysilane, diethyldiphenoxysilane, di-n-propyldimethoxysilane, di-n-propyldiethoxysilane, di-n-propyldi-n-propoxysilane, di-n-propyldiisopropoxysilane, di-n-propyldi-n-butoxysilane, di-n-propyldi-sec-butoxysilane, di-n-propyldi-tert-butoxysilane, di-n-propyldiphenoxysilane, diisopropyldimethoxysilane, diisopropyldiethoxysilane, diisopropyldi-n-propoxysilane, diisopropyldiisopropoxysilane, diisopropyldi-n-butoxysilane, diisopropyldi-sec-butoxysilane, diisopropyldi-tert-butoxysilane, diisopropyldiphenoxysilane, di-n-butyldimethoxysilane, di-n-butyldiethoxysilane, di-n-butyl-di-n-propoxysilane, di-n-butyldiisopropoxysilane, di-n-butyldi-n-butoxysilane, di-n-butyldi-sec-butoxysilane, di-n-butyldi-tert-butoxysilane, di-n-butyldiphenoxysilane, di-sec-butyldimethoxysilane, di-sec-butyldiethoxysilane, di-sec-butyldi-n-propoxysilane, di-sec-butyldiisopropoxysilane, di-sec-butyldi-n-butoxysilane, di-sec-butyldi-sec-butoxysilane, di-sec-butyldi-tert-butoxysilane, di-sec-butyldiphenoxysilane, di-tert-butyldimethoxysilane, di-tert-butyldiethoxysilane, di-tert-butyldi-n-propoxysilane, di-tert-butyldiisopropoxysilane, di-tert-butyldi-n-butoxysilane, di-tert-butyldi-sec-butoxysilane, di-tert-butyldi-tert-butoxysilane, di-tert-butyldiphenoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-tert-butoxysilane, diphenyldiphenoxysilane, divinyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-trifluoropropyltrimethoxysilane and gamma-trifluoropropyltriethoxysilane. These may be used alone or in combination of two or more.

Preferable examples among the compounds of formula (1) described above are tetramethoxysilane, tetraethoxysilane, tetra-n-propoxysilane, tetraisopropoxysilane, tetraphenoxysilane, methyltrimethoxysilane, methyltriethoxysilane, methyltri-n-propoxysilane, methyltriisopropoxysilane, ethyltrimethoxysilane, ethyltriethoxysilane, vinyltrimethoxysilane, vinyltriethoxysilane, phenyltrimethoxysilane, phenyltriethoxysilane, dimethyldimethoxysilane, dimethyldiethoxysilane, diethyldimethoxysilane, diethyldiethoxysilane, diphenyldimethoxysilane, diphenyldiethoxysilane, trimethylmonomethoxysilane, trimethylmonoethoxysilane, triethylmonomethoxysilane, triethylmonoethoxysilane, triphenylmonomethoxysilane and triphenylmonoethoxysilane.

The compounds of the general formula (1) may be hydrolyzed or partially condensed through mixing with water and a catalyst in an organic solvent thereby to form a siloxane polymer. The organic solvent may be those used for the composition described later. The catalyst may be an organic acid, inorganic acid, organic base, inorganic base etc.

Examples of the organic acid include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolein acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, tartaric acid, etc.

Examples of the inorganic acid include hydrochloric acid, nitric acid, sulfuric acid, hydrofluoric acid, phosphoric acid etc.

Examples of the organic base include methanolamine, ethanolamine, propanolamine, butanolamine, N-methylmethanolamine, N-ethylmethanolamine, N-propylmethanolamine, N-butylmethanolamine, N-methylethanolamine, N-ethylethanolamine, N-propylethanolamine, N-butylethanolamine, N-methylpropanolamine, N-ethylpropanolamine, N-propylpropanolamine, N-butylpropanolamine, N-methylbutanolamine, N-ethylbutanolamine, N-propylbutanolamine, N-butylbutanolamine, N,N-dimethylmethanolamine, N,N-diethylmethanolamine, N,N-dipropylmethanolamine, N,N-dibutylmethanolamine, N,N-dimethylethanolamine, N,N-diethylethanolamine, N,N-dipropylethanolamine, N,N-dibutylethanolamine, N,N-dimethylpropanolamine, N,N-diethylpropanolamine, N,N-dipropylpropanolamine, N,N-dibutylpropanolamine, N,N-dimethylbutanolamine, N,N-diethylbutanolamine, N,N-dipropylbutanolamine, N,N-dibutylbutanolamine, N-methyldimethanolamine, N-ethyldimethanolamine, N-propyldimethanolamine, N-butyldimethanolamine, N-methyldiethanolamine, N-ethyldiethanolamine, N-propyldiethanolamine, N-butyldiethanolamine, N-methyldipropanolamine, N-ethyldipropanolamine, N-propyldipropanolamine, N-butyldipropanolamine, N-methyldibutanolamine, N-ethyldibutanolamine, N-propyldibutanolamine, N-butyldibutanolamine, N-(aminomethyl)methanolamine, N-(aminomethyl)ethanolamine, N-(aminomethyl)propanolamine, N-(aminomethyl)butanolamine, N-(aminoethyl)methanolamine, N-(aminoethyl)ethanolamine, N-(aminoethyl)propanolamine, N-(aminoethyl)butanolamine, N-(aminopropyl)methanolamine, N-(aminopropyl)ethanolamine, N-(aminopropyl)propanolamine, N-(aminopropyl)butanolamine, N-(aminobutyl)methanolamine, N-(aminobutyl)ethanolamine, N-(aminobutyl)propanolamine, N-(aminobutyl)butanolamine, methoxymethylamine, methoxyethylamine, methoxypropylamine, methoxybutylamine, ethoxymethylamine, ethoxyethylamine, ethoxypropylamine, ethoxybutylamine, propoxymethylamine, propoxyethylamine, propoxypropylamine, propoxybutylamine, butoxymethylamine, butoxyethylamine, butoxypropylamine, butoxybutylamine, methylamine, ethylamine, propylamine, butylamine, N,N-dimethylamine, N,N-diethylamine, N,N-dipropylamine, N,N-dibutylamine, trimethylamine, triethylamine, tripropylamine, tributylamine, tetramethylammoniumhydroxide, tetraethylammoniumhydroxide, tetrapropylammoniumhydroxide, tetrabutylammoniumhydroxide, tetramethylethylenediamine, tetraethylethylenediamine, tetrapropylethylenediamine, tetrabutylethylenediamine, methylaminomethylamine, methylaminoethylamine, methylaminopropylamine, methylaminobutylamine, ethylaminomethylamine, ethylaminoethylamine, ethylaminopropylamine, ethylaminobutylamine, propylaminomethylamine, propylaminoethylamine, propylaminopropylamine, propylaminobutylamine, butylaminomethylamine, butylaminoethylamine, butylaminopropylamine, butylaminobutylamine, pyridine, pyrrole, piperazine, pyrrolidine, piperidine, picoline, morpholine, methylmorpholine, diazabicyclooctane, diazabicyclononane, diazabicycloundecene, etc.

Examples of the inorganic base include ammonia, sodium hydroxide, potassium hydroxide, barium hydroxide, calcium hydroxide, etc.

The amount of the catalyst may be adjusted such that the concentration is 1 to 1000 ppm, particularly 5 to 800 ppm in the reaction system of the hydrolysis reaction.

The additional amount of water is preferably 1.5 to 4.0 moles per one mole of hydrolysis groups of the entire compounds expressed by the general formula (1).

In cases where the compounds of the general formula (1) are hydrolyzed, the resulting alcohol and water present are preferably removed. The removal of the alcohol yielded from the hydrolysis and the water may enhance the storage stability and film formability, in addition, the dispersibility of the colorant may be enhanced, and sedimentation may be suppressed. The removal of alcohol and water is carried out by vacuum distillation. The vacuum distillation is carried out at a vacuum degree of 39.9×10² to 39.9×10³ Pa (about 30 to 300 mmHg), preferably at 66.5×10² to 26.6×10³ Pa (about 50 to 200 mmHg) and a temperature of 20 to 100 degrees C. The removal of the alcohol yielded from the hydrolysis and the water is carried out, for example, to no more than 10% by mass in the composition with lower refractive indices, preferably to no more than 5% by mass, more preferably to no more than 2% by mass.

It is preferred that the siloxane polymer has a hydrocarbon group attached to the Si atoms of its skeleton, in which the hydrocarbon group has a carbon number of about 5 to 20 and may have a substituent. The siloxane polymer with such a group may improve the uniformity of the coatings formed by coating the composition.

The hydrocarbon group is preferably those expressed by the following formula:

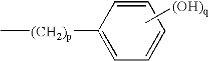

In the formula above, p is an integer of 0 to 5; q is an integer of 0 to 5. Preferably, p is 0 or 1, and q is 0 or 1.

In addition, the siloxane polymer is preferably a ladder-type siloxane polymer. Preferably, the ladder-type siloxane polymer contains constitutional units expressed by formulas (a) and (b).

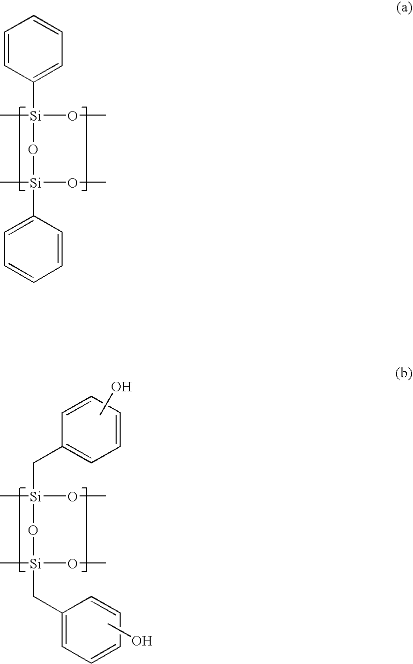

In the case of siloxane polymers containing constitutional units expressed by the formulas (a) and (b), the content of the constitutional units expressed by the formula (b) is preferably 10 to 90 mole %, more preferably 20 to 80 mole % The composition according to the present invention contains a colorant. The colorant may be anything without limitation as long as it is capable of coloring the coating formed from the composition. Examples of the colorant include Co oxide, copper oxide, chrome compounds, nickel oxide, manganese oxide, neodymium oxide, titanium black, carbon blacks, etc.; particularly preferable are Co oxide and carbon blacks with higher tinting power. In addition, organic pigments may be used individually or in combinations thereof.

These organic pigments may be those compounds identified as pigments with color indices (C.I.) (published by The Society of Dyers and Colourists); specific examples are those of color indices (C.I.) below.

C.I. Pigment Yellow 1 (hereinafter, expressed merely by numbers), 3, 11, 12, 13, 14, 15, 16, 17, 20, 24, 31, 53, 55, 60, 61, 65, 71, 73, 74, 81, 83, 86, 93, 95, 97, 98, 99, 100, 101, 104, 106, 108, 109, 110, 113, 114, 116, 117, 119, 120, 125, 126, 127, 128, 129, 137, 138, 139, 147, 148, 150, 151, 152, 153, 154, 155, 156, 166, 167, 168, 175, 180, 185;

C.I. Pigment Orange 1 (hereinafter, expressed merely by numbers), 5, 13, 14, 16, 17, 24, 34, 36, 38, 40, 43, 46, 49, 51, 55, 59, 61, 63, 64, 71, 73;

C.I. Pigment Violet 1 (hereinafter, expressed merely by numbers), 19, 23, 29, 30, 32, 36, 37, 38, 39, 40, 50;

C.I. Pigment Red 1 (hereinafter, expressed merely by numbers), 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1, 63:2, 64:1, 81:1, 83, 88, 90:1, 97, 101, 102, 104, 105, 106, 108, 112, 113, 114, 122, 123, 144, 146, 149, 150, 151, 155, 166, 168, 170, 171, 172, 174, 175, 176, 177, 178, 179, 180, 185, 187, 188, 190, 192, 193, 194, 202, 206, 207, 208, 209, 215, 216, 217, 220, 223, 224, 226, 227, 228, 240, 242, 243, 245, 254, 255, 264, 265;

C.I. Pigment Blue 1 (hereinafter, expressed merely by numbers), 2, 15, 15:3, 15:4, 15:6, 16, 22, 60, 64, 66; C.I. Pigment Green 7, C.I. Pigment Green 36, C.I. Pigment Green 37; C.I. Pigment Brown 23, C.I. Pigment Brown 25, C.I. Pigment Brown 26, C.I. Pigment Brown 28, etc.

It is preferred that the inventive composition with lower refractive indices contains a solvent such as organic solvents. Examples of the organic solvents include aliphatic hydrocarbon solvents such as n-pentane, i-pentane, n-hexane, i-hexane, n-heptane, i-heptane, 2,2,4-trimethylpentane, n-octane, i-octane, cyclohexane and methylcyclohexane; aromatic hydrocarbon solvents such as benzene, toluene, xylene, ethylbenzene, trimethylbenzene, methylethylbenzene, n-propylbenzene, i-propylbenzene, diethylbenzene, i-butylbenzene, triethylbenzene, di-1-propylbenzene, n-amylnaphthalene and trimethylbenzene; monoalcohol solvents such as methanol, ethanol, n-propanol, i-propanol, n-butanol, i-butanol, sec-butanol, t-butanol, n-pentanol, i-pentanol, 2-methylbutanol, sec-pentanol, t-pentanol, 3-methoxybutanol, n-hexanol, 2-methylpentanol, sec-hexanol, 2-ethylbutanol, sec-heptanol, 3-heptanol, n-octanol, 2-ethylhexanol, sec-octanol, n-nonylalcohol, 2,6-dimethylheptanol, n-decanol, sec-undecylalcohol, trimethyl nonylalcohol, sec-tetradecylalcohol, sec-heptadecylalcohol, phenol, cyclohexanol, methylcyclohexanol, 3,3,5-trimethylcyclohexanol, benzyl alcohol, phenylmethylcarbinol, diacetone alcohol and cresol; multivalent alcohol solvents such as ethylene glycol, 1,2-propylene glycol, 1,3-butylene glycol, 2,4-pentanediol, 2-methyl-2,4-pentanediol, 2,5-hexanediol, 2,4-heptanediol, 2-ethyl-1,3-hexanediol, diethyleneglycol, dipropyleneglycol, triethyleneglycol, tripropyleneglycol and glycerin; ketone solvents such as acetone, methylethylketone, methyl-n-propylketone, methyl-n-butylketone, diethylketone, methyl-1-butylketone, methyl-n-pentylketone, ethyl-n-butylketone, methyl-n-hexylketone, di-1-butylketone, trimethylnonanone, cyclohexanone, methylcyclohexanone, 2,4-pentanedione, acetonyl acetone, diacetone alcohol, acetophenone and fenchone; ether solvents such as ethylether, i-propylether, n-butylether, n-hexylether, 2-ethylhexylether, ethyleneoxide, 1,2-propyleneoxide, dioxolane, 4-methyldioxolane, dioxane, dimethyl dioxane, ethyleneglycolmonomethylether, ethyleneglycolmonoethylether, ethyleneglycoldiethylether, ethyleneglycolmono-n-butylether, ethyleneglycolmono-n-hexylether, ethyleneglycolmonophenylether, ethyleneglycolmono-2-ethylbutylether, ethyleneglycoldibutylether, diethyleneglycolmonomethylether, diethyleneglycolmonoethylether, diethyleneglycoldiethylether, diethyleneglycolmono-n-butylether, diethyleneglycoldi-n-butylether, diethyleneglycolmono-n-hexylether, ethoxytriglycol, tetraethyleneglycoldi-n-butylether, propyleneglycolmonomethylether, propyleneglycolmonoethylether, propyleneglycolmonopropylether, propyleneglycolmonobutylether, dipropyleneglycolmonomethylether, dipropyleneglycolmonoethylether, tripropyleneglycolmonomethylether, tetrahydrofuran and 2-methyl tetrahydrofuran; ester solvents such as diethylcarbonate, methyl acetate, ethyl acetate, gamma-butyrolactone, gamma-valerolactone, n-propyl acetate, i-propyl acetate, n-butyl acetate, i-butyl acetate, sec-butyl acetate, n-pentylacetate, sec-pentylacetate, 3-methoxybutyl acetate, methylpentylacetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethyleneglycol monomethylether acetate, ethyleneglycol monoethylether acetate, diethyleneglycol monomethylether acetate, diethyleneglycol monoethylether acetate, diethyleneglycol mono-n-butylether acetate, propyleneglycol monomethylether acetate, propyleneglycol monoethylether acetate, propyleneglycol monopropylether acetate, propyleneglycol monobutylether acetate, dipropyleneglycol monomethylether acetate, dipropyleneglycol monoethylether acetate, glycol diacetate, methoxytriglycol acetate, ethyl propionate, n-butyl propionate, i-amyl propionate, diethyl oxalate, di-n-butyl oxalate, methyl lactate, ethyl lactate, n-butyl lactate, n-amyl lactate, diethyl malonate, dimethyl phthalate and diethyl phthalate; nitrogen-containing solvents such as N-methylformamide, N,N-dimethylformamide, N,N-diethylformamide, acetamide, N-methyl acetamide, N,N-dimethyl acetamide, N-methylpropionamide and N-methylpyrrolidone; sulfur-containing solvents such as dimethyl sulfide, diethyl sulfide, thiophene, tetrahydrothiophene, dimethylsulfoxide, sulfolane and 1,3-propane sultone. These may be used alone or in combinations of two or more.

There is no set limit on the amount of the solvents used in the present invention; preferably, the amount is adjusted such that the concentration of total solid content is about 1 to 30% by mass in the composition with lower refractive indices, more preferably about 5 to 25% by mass. The concentration range may lead to an appropriate range of film thickness of the coated film and also excellent storage stability.

Preferably usable solvents are propyleneglycol monomethyletheracetate (PGMEA), 3-methoxybutylacetate, n-butanol, methylethylketone, acetone, butylacetate and propyleneglycol dimethylether. These solvents are utilized in an amount of 1 to 100% by mass based on the total solvents, more preferably 5 to 30% by mass.

In particular, 3-methoxybutylacetate and n-butanol are preferable from the viewpoint that the dispersibility of colorants may be enhanced, the effect to suppress sedimentation is significant, which can substantially uniformly color the silica-based coatings that is formed from the composition. Furthermore, the storage stability of the composition may be improved, gelatinization may be prevented, and the coating properties and uniformity may be enhanced.

However, water, methanol and ethanol are preferably excluded from the solvent, since these solvents tend to cause agglomeration, sedimentation or gelatinization in the composition.

A dispersant may be added to the composition in order to disperse the colorant. The dispersant may be anionic compounds, cationic compounds, nonionic compounds or polymer compounds. Usually anionic compounds and polymer compounds are preferable; the anionic compounds are exemplified by alkylbenzene sulfonic acids and alkylbenzene sulfonates. Among these, alkylbenzene sulfonic acids are preferable in view of easy availability and excellent dispersibility.

In cases where a hydrolysis product and/or a partial condensate of the silane compounds is utilized for the siloxane polymer, the dispersant is preferably added.

Surfactants may be added to the inventive composition in order to improve the coating properties or to prevent striations. Examples of the surfactants include nonionic surfactants, anionic surfactants, cationic surfactants and amphoteric surfactants, and also silicone surfactants, polyalkyleneoxide surfactants and poly(meth)acrylate surfactants.

The composition according to the present invention may be favorably utilized for concealing pattern shapes formed on semiconductor elements. The method for forming colored silica-based coatings from the composition may be exemplified by those below.

A coating film is initially formed on a substrate such as base materials in a predetermined thickness of the composition by way of a coating process such as rotary coating, flow casting coating and roll coating processes. The thickness of the coating film may be properly selected.

The coating film is then baked on a hot plate. This bake treatment evaporates the organic solvent in the coating film and causes a reaction between molecules of the siloxane polymer and thus promoting the polymerization. The bake temperature at this treatment is about 80 to 500 degrees C. for example, more preferably about 80 to 300 degrees C. This bake treatment may be carried out in plural steps with different bake temperatures.

Then heating is carried out to form a colored silica-based coating. The heating temperature is usually 350 degrees C. or more, preferably about 350 to 450 degrees C.

### EXAMPLES

### Example 1

Fifty grams of PGMEA solution (solid content: 20% by mass) of a siloxane polymer containing the constitutional units (a) and (b) described above ((a):(b)=3:7 (mole ratio), mass average molecular weight Mw=9700) and 50 g of a dispersion of carbon black (PD color TO-600K (by Mikuni Color Ltd.) as a colorant in 3-methoxybutylacetate (solid content 20% by mass) were mixed to form 100 g of a composition for forming black silica-based coatings.

The composition was coated onto a glass substrate using a spin coater (by Tazmo Co.), then was dried in an oven at 140 degrees C. for 30 minutes, then heated at 400 degrees C. for 30 minutes, thereby to form a black silica-based coating 610 nm thick.

### Example 2

A total of 220.0 g of methyltrimethoxysilane, 246.0 g of tetramethoxysilane and 301.0 g of propyleneglycol monopropylether were mixed and stirred, to which 204.0 g of water and 52 μL of nitric acid with 60% by mass concentration were added and stirred for 3 hours, followed by allowing to react for 2 days at room temperature. After removing water and alcohol from the reaction solution, the concentration of the solid content was adjusted to 20% by mass using PGMEA thereby to prepare a siloxane polymer solution. The Mw of the siloxane polymer was 1400.

50 g of the resulting solution and 50 g of the dispersion of carbon black (PD color TO-600K) in 3-methoxybutylacetate (solid content 20% by mass) were mixed to form a composition for forming black silica-based coatings. The composition was coated onto a glass substrate, and dried and heated in a similar manner as Example 1 thereby to form a black silica coating.

### Example 3

A total of 220.0 g of methyltrimethoxysilane, 246.0 g of tetramethoxysilane and 301.0 g of propyleneglycol monopropylether were mixed and stirred, to which 204.0 g of water and 52 μL of nitric acid with 60% by mass concentration were added and stirred for 3 hours, followed by allowing to react for 2 days at room temperature. After removing water and alcohol from the reaction solution, the concentration of the solid content was adjusted to 20% by mass using n-butanol thereby to prepare a siloxane polymer solution. The Mw of the siloxane polymer was 1300.

A mixture of 1 g of dodecylbenzene sulfonic acid and 4 g of Co oxide was added to 50 g of the resulting siloxane polymer solution to form a composition for forming black silica-based coatings. The composition was coated onto a glass substrate, and dried and heated in a similar manner as Example 1 thereby to form a black silica coating.

### Example 4

73.9 g (0.45 mole) of triethoxysilane was dissolved into 799.0 g (8.87 moles) of ethyleneglycol dimethylether and the solution was stirred, to which a mixture of 24.2 g (1.34 moles) of pure water and 5 ppm of concentrated nitric acid were dropped while stirring slowly, then the mixture was stirred for 3 hours, followed by allowing to stand at room temperature for 6 days to prepare a solution. After removing water and alcohol from the reaction solution, the concentration of the solid content was adjusted to 10% by mass using PGMEA thereby to prepare a siloxane polymer solution.

A mixture of 1 g of dodecylbenzene sulfonic acid and 4 g of Co oxide was added to 50 g of the resulting siloxane polymer solution to form a composition for forming black silica-based coatings. The composition was coated onto a glass substrate, and dried and heated in a similar manner as Example 1 thereby to form a black silica coating.

### Example 5

A siloxane polymer solution was prepared in the same manner as Example 2, except that the water and alcohol in the reaction solution were not removed from the reaction solution and the concentration of the solid content was adjusted to 20% by mass. Then 50 g of the siloxane polymer solution and 50 g of the dispersion of carbon black (PD color TO-600K) in 3-methoxybutylacetate (solid content 20% by mass) were mixed to form a composition for forming black silica-based coatings.

The composition was coated onto a glass substrate, and dried and heated in a similar manner as Example 1 thereby to form a black silica coating. However, agglomeration or sedimentation occurred in the composition in this Example, therefore, the composition had to be sufficiently stirred before the coating.

### Example 6

A siloxane polymer solution was prepared in the same manner as Example 2, except that the water and alcohol in the reaction solution were not removed from the reaction solution and the concentration of the solid content was adjusted to 20% by mass.

Then 50 g of the dispersion of carbon black (PD color TO-600K) in 3-methoxybutylacetate (solid content 20% by mass) was added to 50 g of the siloxane polymer solution to form a composition for forming black silica-based coatings.

The composition was coated onto a glass substrate, and dried and heated in a similar manner as Example 1 thereby to form a black silica coating. Sedimentation occurred in the composition, therefore, the composition had to be sufficiently stirred before the coating.

### Example 7

A composition for forming black silica-based coatings was prepared in the same manner as Example 4, except that the dodecylbenzene sulfonic acid was not added. The composition was coated onto a glass substrate, and dried and heated in a similar manner as Example 1 thereby to form a black silica coating.

However, agglomeration or sedimentation occurred in the composition in this Example, therefore, the composition had to be sufficiently stirred immediately after the preparation and then was coated. Gelatinization occurred in the composition one hour after its preparation.

Table 1 shows the results of evaluations of the compositions for forming the black silica-based coatings prepared in Examples 1 to 7. The subjects of the evaluation were coating evaluations of the black silica-based coatings, storage stability and colorant dispersibility.

The coating evaluation was judged with respect to whether or not there was concealing in the silica-based coatings after heating. The storage stability was judged with respect to occurrence of gelatinization after 3 days of storage. The dispersibility was judged with respect to occurrence of sedimentation.

TABLE 1

| | Coating | Storage | Colorant |
|---|---|---|---|
| | Evaluation | Stability | Dispersibility |
| Example 1 | pass | pass | pass |
| Example 2 | pass | pass | pass |
| Example 3 | pass | pass | pass |
| Example 4 | pass | pass | pass |
| Example 5 | pass | pass | non-pass |
| Example 6 | pass | pass | non-pass |
| Example 7 | pass | non-pass | non-pass |

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A composition for forming colored silica-based coatings, comprising a siloxane polymer, a colorant and a solvent.

2. The composition according to claim 1, wherein the siloxane polymer comprises a hydrolysis product and/or a partial condensate of at least one silane compound expressed by the formula (1) below:
RₙSiX₄₋ₙ (1)
in which each R represents independently a hydrogen atom or a monovalent organic group, X represents a hydrolyzable group, n is an integer of 0 to 2 and plural Rs may be identical or different from each other.

3. The composition according to claim 1, wherein the siloxane polymer is a ladder-type siloxane polymer.

4. The composition according to claim 1, wherein the group expressed by the formula below is attached to an Si atom of the siloxane polymer. 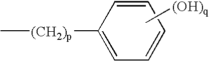
in formula above, p is an integer of 0 to 5, and q is an integer of 0 to 5.

5. The composition according to claim 3, wherein the ladder-type siloxane polymer contains constitutional units expressed by formulas (a) and (b).

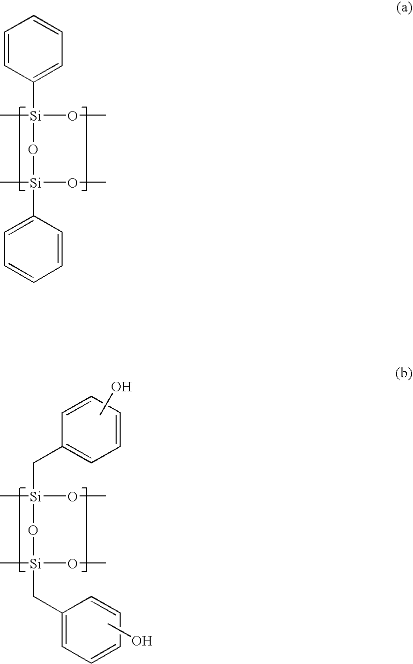

6. The composition according to claim 1, wherein the colorant is a black pigment.

7. The composition according to claim 1, wherein the solvent contains at least one selected from the group consisting of propyleneglycol monomethyletheracetate, 3-methoxybutylacetate, n-butanol, methylethylketone, acetone, butylacetate and propyleneglycol dimethylether.

8. The composition according to claim 1, wherein the composition further comprises a dispersant.
